(19) United States
(12) Patent Application Publication
(10) Pub. No.: US 2011/0169334 A1
(43) Pub. Date: Jul. 14, 2011

(54) Renewable Energy Appliance

(76) Inventor: Dennis Lee Williams, Dolores, CO (US)

(21) Appl. No.: 13/004,733

(22) Filed: Jan. 11, 2011

Related U.S. Application Data
(60) Provisional application No. 61/335,673, filed on Jan. 11, 2010.

(51) Int. Cl. H02J 3/04; F03D 9/00; F03D 7/00; F03D 3/00

(52) U.S. Cl. 307/72; 290/55; 290/44

(57) ABSTRACT

A Renewable Energy Appliance incorporates an integrated, attractive, energy collection, conversion management and storage system in a self- contained deliverable structure. The appliance prioritizes the production of electrical energy using ambient wind and solar energy sources, while at the same time, providing for the substitution of fossil fuels on an expanded or as-needed basis. The appliance can be delivered, pre-assembled and programmed to provide electrical energy for many requirements with minimal environmental impact on the location site. It can be utilized in configurations to offset the grid, stand alone and/or to provide reliable back-up power to an electrical energy consuming load or grid at the point of use. The appliance can be certified to meet code compliance “plug and play” use. It is self-managed, self- supporting and includes all of the necessary equipment to safely collect, convert, store and deliver electrical power (while prioritizing the consumption of renewable energy sources), thereby reducing the carbon footprint from the grid or generator provided power.

### CROSS-REFERENCE TO RELATED APPLICATION

This application claims the benefit of U.S. provisional application No. 61/335,673, filed on Jan. 11, 2010.

### BACKGROUND OF THE INVENTION

1. Field of the Invention

This invention relates to a device for generating renewable energy, especially wind and solar energy.

2. Description of the Related Art

Use of wind and solar energy collection is well known and in wide use. It is finding increased implementation across a broad spectrum of applications ranging from single unit installations to major power farms. They are often unsightly, noisy and undesirable to the general public, harmful to wildlife and much of the energy is lost during long distance power transmission.

Single unit wind generators have a large impact on surroundings for supporting structure; they are often noisy, damaging to wildlife and difficult to service or repair. The units often must be located a considerable distance from the point of need due to the requirement for support structures and to reduce noise. Controlling the speed of many wind turbines requires furling and maintaining a constant load to prevent damage to the device and surroundings.

Location and mounting of solar collecting panels requires large supporting structures to be placed in proper orientation with the angle of the sun. This often requires locating the collectors at some distance from the point of need, thereby reducing output. The orientation of the panels makes them susceptible to wind damage, snow and ice build-up and has an overall negative impact to the visual esthetics of the installation.

Incorporating renewable energy often requires locating hazardous noisy devices (high speed wind turbines, batteries, and fueled back-up generators) on or near inhabited structures. Locating the components at distant locations reduces the power output of the low voltage high current side of the circuitry. Servicing the control and storage devices requires exposure to hazardous conditions as they are often positioned on high structures making them difficult to access. Incorporating renewable energy can result in less than desirable esthetics due to the footprint of its supporting structure, thereby discouraging its acceptance. Incorporating renewable energy into new structures increases design costs and can limit structural variations due to location and the hazards associated with the collectors on the structure.

U.S. Pat. No. 4,468,169, entitled Regulated High Torque Flexible Bladed Wind Wheel, covers an improved horizontally mounted wind wheel which comprises a framework mounted for rotation in a horizontal plane on a central upright drive shaft. It contains a plurality of secondary shafts supported for rotation on said framework near the periphery thereof, a vane mounted near one end thereof to each secondary shaft, a plurality of vane stops on the framework positioned radially inwardly of the secondary shafts for limiting the rotation of the vanes, each of said secondary shafts being mounted for rotation about an axis which is tilted with respect to a vertical to said horizontal whereby each vane has a preferred predetermined rest position defined by the direction of tilting of each axis from a said vertical.

A Vertical Axis Wind Turbine is the subject of U.S. Pat. No. 7,083,382. This device of this patent provides a prime mover for harnessing energy from a flow of fluid, the prime mover comprising a shaft having a rotational axis, arranged to be rotatably mounted to a substructure, the shaft comprising at least one arm extending radially from the shaft, each arm comprising at least one blade wherein each blade is oriented such that flow action on the blade affects rotation of the shaft characterized in that each blade is movably mounted on an arm and each blade is movable from a first position, having a first drag, to a second position, having a second drag, wherein the first drag is higher than the second drag. The prime mover of the invention provides substantial reduced drag in a flow of fluid, and an increased torque output, compared to prior art prime movers.

A wind rotor forms the invention described in U.S. Pat. No. 6,824,348, entitled Wind Rotor Operable in Slow Wind Speeds; it comprises a base, a rotor frame rotationally supported on the base for movement about a substantially vertical axis in one of a clockwise or counter clockwise direction, and a plurality of wind receiving vanes pivotally disposed on the rotor frame for movement about a substantially vertical axis in a clockwise and counterclockwise direction between a first closed position and a second open position. The movement of each vane from the first closed position to the second open position further being independent of the other vanes. A variable resistance damping mechanism assembly is disposed between each vane and the rotor frame. The variable resistance damping mechanism is configured to provide a damping in both the clockwise and the counterclockwise directions, and to dampen a greater amount in one of the clockwise or counterclockwise directions than in the other.

### BRIEF SUMMARY OF THE INVENTION

The appliance incorporates a vertical axis turbine. The turbine can vary the contact angle of the blade, depending on wind pressure. Effectively, the variable timing allows for control of the angle between the blade and the wind. This reduces the noise and increases the torque of the windmill. It acts as a dampener between the turbine and the sail, reducing noise created from any sudden impact. It increases torque by giving the blade a variable contact angle with the wind during times when the arm is approaching parallel to the wind direction and is located in front of the wheel, as the wheel rotates. This contact angle increases the contact surface area between the blade and the wind, allowing the wheel to harness more energy from the wind. Note that “front” of the wheel refers to the side where the wind is blowing and hits the wheel initially. “Back” of the wheel refers to the opposite or shaded side from where the wind is blowing. The turbine truss is designed to reduce non-productive forces on the support structure and to lower the effective center of gravity of the supporting structure. The turbine structure includes a method of incorporating solar collection above the turbine supported by a common support and shaft mechanism.

U.S. Pat. No. 4,468,169 is a vertical axis windmill with an arm and a free-moving blade similar to the present invention, however, it does not incorporate any type of “variable stops” that can dampen noise or increase the contact angle between the wind and the blade.

U.S. Pat. No. 7,083,382 is also a vertical axis windmill with an arm that may or may not contain multiple blades in each arm. It may or may not contain multiple wheels stacked on top of each other. It also may or may not have a “stop” mechanism that controls the angle of the blade and the wind. The main difference with the present invention is the design of the “stops.” The present invention utilizes “Wind Force Variable Timing Stops” on each blade as mentioned, whereas U.S. Pat. No. 7,083,382 utilizes a “slip stop mechanism” in order to control the contact angle between the wind and the blade. The “slip stop” controls how far the blade swings outwardly when the arm and blade is located in the “back” of the wheel.

U.S. Pat. No. 6,824,348 is also a vertical axis windmill. It also has a “stop” mechanism that controls the angle of the blade and the wind. The main difference between this patent and the present invention is also in the design of the “stops.” The present invention utilizes “Wind Force Variable Timing Stops” on each blade as mentioned, whereas U.S. Pat. No. 6,824,348 utilizes a type of hydraulic piston in order to control the contact angle between the wind and the blade. This control was incorporated in the design in order to slow the rotation of the arms. The hydraulic pistons control how far the blade swings outwardly when the arm and blade is located in the “front” of the wheel.

The present invention is capable of producing energy from both solar and/or wind sources, whereas the mentioned prior art produce energy from wind only. U.S. Pat. No. 4,468,169, U.S. Pat. No. 7,083,382, and U.S. Pat. No. 6,824,348 all harness energy from wind only.

In numerous applications the present invention can blend wind and/or solar, fossil fueled (grid) and stored energy increasing output and reliability while insuring maximum utilization of the available renewable energies.

The present invention has improved sail stops (Wind Force Variable Sail Stops) incorporated in the design that can dampen noise and increase torque of a vertical axis wind truss by positioning the sails in a sheering position at the leading edge portion of the rotation.

The unique low-speed vertical axis truss mounted turbine operates at less than 20 RPM with a much increased torque over conventional designs, making it safer, quieter and simpler to manufacture. The lower speed and horizontal rotation provide for a lower profile device, thereby reducing the effect of the wind forces on the supporting structure. The lower speed requires no additional controls or mechanism to protect it from over speed as the circumference of the truss can go no faster than the wind going past it in the force direction. Strong wind gusts flex the variable blade torque mechanism, thus preventing damage to the device.

This invention provides for the mounting of solar collectors and its structural support directly above the wind turbine on the same axis and axle to minimize overall footprint and reduce structural support and controls.

Providing a truss mounted horizontal installation improves overall installation with less supporting structure as the surface area exposed to horizontal wind force is reduced. This configuration provides an improved method of constantly positioning the angle for increased output. The mechanism places the solar collectors facing down during night hours to reduce frost, snow and ice build-up and positions them in a safer horizontal position during high wind condition reducing horizontal forces on the supporting structure and prevents degradation of the collectors from flexing stress on the collectors.

The present invention incorporates a complete energy management appliance encompassing the improved combination solar and wind collecting device. The renewable energy collection device mounts above a supporting structure design that provides safe enclosure of the energy storage, control circuitry and related devices, maximizing efficiency by close proximity, temperature and combining common control circuitry. The attractive support tower and controlling devices combine to insure an appropriate center of gravity to allow for free standing deliverable electrical power.

This appliance can provide an attractive design with selectable exteriors which complement its surroundings. The device can be located in suitable locations at a distance to improve its production with little or no impact to new or existing structures. It is self-supporting, reducing the need to excavate for footings and foundations. All energy collection and controls are located in close proximity reducing loss of power from long wire runs while sharing like circuitry, support structure and improving production output. The enclosure provides ease of maintenance while protecting the hazardous devices from unauthorized access. The factory-built deliverable appliance provides a supportable, less intrusive, approach to renewable energy at many locations as a grid tie, backup or primary source of electrical energy.

### BRIEF DESCRIPTION OF THE SEVERAL VIEWS OF THE DRAWING

The drawing shows the overall invention.

### DETAILED DESCRIPTION OF THE INVENTION

The modular code compliant, energy appliance consists of an attractive enclosed, structural support assembly for placement of energy production collectors, storage and supporting circuitry. The size and shape of the structure reduce the effects of horizontal wind forces on the appliance; this, coupled with a low center of gravity, results in reducing the minimal requirements for site preparation for footings or foundation. It provides for safe, efficient enclosed placement of power management components in close proximity, improving efficiency and sharing common electrical control circuitry, thus reducing power loss from long distance conductors on the low voltage side. Separate vented enclosures protect hazardous batteries and gasses from possible human or mechanical contact while improving access and safety for servicing. Location of circuitry and energy storage, aid and assist temperature control of circuits and storage batteries, improving efficiency. It provides for placement of the back-up generator in an efficient, safe and quiet location. Placement of renewable energy collectors (5)(6), back-up generator(4), energy storage(3), and common controls and circuitry(2), in a compact structure(1), provides for efficient energy production, and ease of maintenance with a safer, quieter operation, and a more acceptable footprint.

The wind (5) and solar(6) collection is combined into one horizontal plane assembly to provide the most efficient output from available renewable resources sharing a vertical axis structural support. The wind turbine (5) is a low speed and high torque design that will withstand high winds while maintaining lower speeds, speeds less than 200 RPM. The Turbine (7) will not turn any faster than the wind passing in the direction of force. At 100 MPH and a circumference of approximately 60 feet, it could turn 200 RPM; however, the centrifugal force of the blades swings them outward on the down-wind side slapping the wind and reducing RPM. This force counteracts the blades pushing in the direction of force. The speed can be set by the length and weight of the blades to achieve the desired maximum RPM. To prevent excessive noise and force on the turbine and structure, the flexible blades (9) are designed to pass their intended stop position, reducing the force on the turbine and structure. An improved Wind Force Variable Timing mechanism (10) produces slightly better speed at low wind velocity on the leading edge and better control of blade bending on the wind force position (parallel with the wind). The larger diameter permanent magnet alternator (11) provides adequate output at lower speeds eliminating need for gearing-up. This maintains a lower generator speed and voltage eliminating the requirement to maintain constant load on the turbine for over-speed over-voltage protection in higher winds. Lower speeds are safer, quieter and less harmful to wildlife. The alternator circuitry provides continuous changing of the windings from parallel to series, thus maximizing output at any speed.

The solar collectors (12) are mounted above the wind turbine on the same shaft to insure an unobstructed position with the sun. The horizontal plane of the collectors reduces wind force on the collectors reducing wind push on the entire assembly including the supporting tower. The horizontal plane mounting has less exposure to excessive wind force that could damage the collectors, support structure and solar tracking mechanism. The electronic radial position solar tracking system (13) can also provide protection from excessive wind force by positioning the solar collectors more horizontally during excessive winds thus reducing force damage on the entire mechanism. Positioning the collectors facing down during icing, frost or snow produces better output when solar rays return.

This arrangement for supporting and housing all power generating and storage requirements in and on one structural assembly provide the basis for an energy appliance (14). This embodiment represents an encompassing apparatus that is modular and portable with a smaller footprint, providing a safer and more desirable application for applying renewable energy at the point of consumption in many locations.

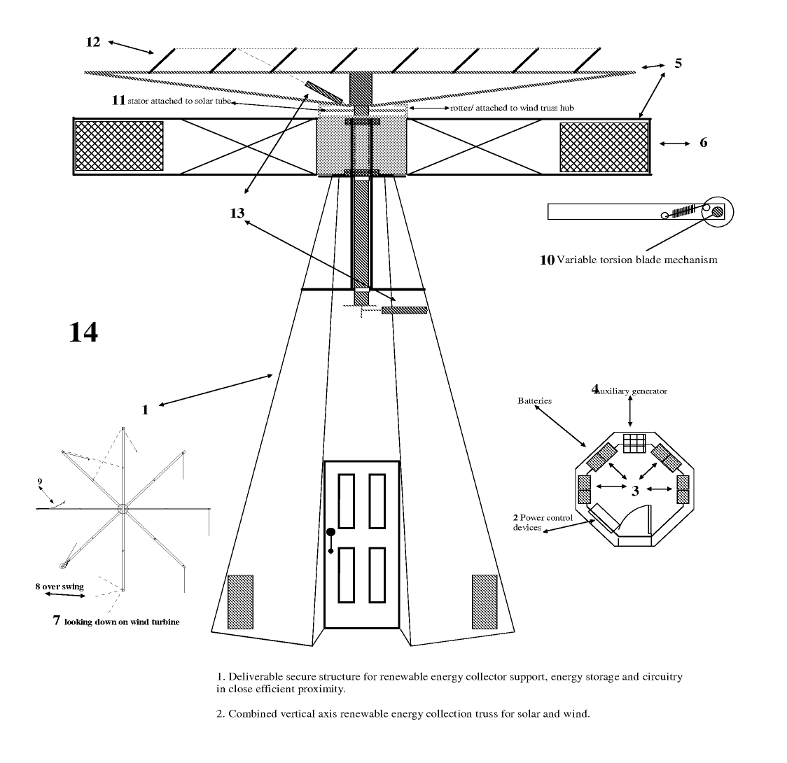

While the apparatus presented in FIG. 1 and the above description provide an embodiment of the invention, they are for illustrative purposes only, and in no way should they be interpreted as limiting the scope of the invention. Other variations are contemplated as being part of the invention, and these are to be limited only by the scope of the following claims.

I claim:

1. A deliverable all encompassing energy collection, storage and power management appliance for (plug and play) delivery of electrical energy to offset and or back-up utility grid power or stand alone, which comprises: a renewable energy support structure and or fueled generator energy system, is assembled into one secure, stand-alone, attractive appliance that can be delivered to the consumer ready to provide usable electrical power gathered and blended from multiple sources prioritizing renewable energies at a point of consumption.

2. The appliance as recited in claim 1, further comprising: a means for utilizing fossil fueled and stored energy or grid energy ensuring the maximum utilization of renewable energies

3. The appliance as recited in claim 1, further comprising: an improved Wind Force Variable Sail timing mechanism designed to provide variable sail timing thus improving low speed wind power production during the wind force side of the rotation and providing a quieter stronger operation in heavy or turbulent winds.

4. The appliance as recited in claim 3, further comprising: a means for utilizing fossil fueled and stored energy or grid energy ensuring the maximum utilization of renewable energies.

5. The appliance as recited in claim 1, further comprising: a low speed (less than 30 RPM) bird friendly vertical axis wind turbine structure with imbedded direct drive low speed permanent magnet generator.

6. The appliance as recited in claim 5, further comprising: a means for utilizing fossil fueled and stored energy or grid energy to ensure the maximum utilization of renewable energies

7. The appliance as recited in claim 1, further comprising: an improved Wind Force Variable Sail timing mechanism designed to provide variable sail timing thus improving low speed wind power production during the wind force side of the rotation and providing a quieter stronger operation in heavy or turbulent winds.

8. The appliance as recited in claim 7, further comprising: a means for utilizing fossil fueled and stored energy or grid energy to ensure the maximum utilization of renewable energies.

9. The appliance as recited in claim 3, further comprising: a low speed (less than 30 RPM) bird friendly vertical axis wind turbine structure with imbedded direct drive low speed permanent magnet generator; and an improved Wind Force Variable Sail timing mechanism designed to provide variable sail timing thus improving low speed wind power production during the wind force side of the rotation and providing a quieter stronger operation in heavy or turbulent winds.

10. The appliance as recited in claim 9, further comprising: a means for utilizing fossil fueled and stored energy or grid energy to ensure the maximum utilization of renewable energies.

11. The appliance as recited in claim 1, further comprising: flexible sails, designed so that under extreme wind conditions, said sails will bypass their intended stop positions, thereby reducing the rotational velocity torque and reducing the horizontal force on the turbine and structure.

12. The appliance as recited in claim 11, further comprising: a means for utilizing fossil fueled and stored energy or grid energy to ensure the maximum utilization of renewable energies.
